(19) United States
(12) Patent Application Publication
(10) Pub. No.: US 2013/0179312 A1
(43) Pub. Date: Jul. 11, 2013

(54) Methods and Systems for Controlling Costs Associated with a Third-Party Vendor of a Network Provider

(71) Applicant: Mohammed Al-Hilali, Basingstoke (GB)

(72) Inventor: Mohammed Al-Hilali, Basingstoke (GB)

(73) Assignee: VERIZON PATENT AND LICENSING INC., Basking Ridge, NJ (US)

(21) Appl. No.: 13/345,091

(22) Filed: Jan. 6, 2012

(51) Int. Cl. G06Q 30/04; G06Q 40/00

(52) U.S. Cl. 705/30

(57) ABSTRACT

An exemplary method includes a cost control system 1) acquiring estimated cost data from an estimated cost management system, 2) acquiring quoted cost data from an order management system independent of the estimated cost management system, 3) acquiring invoiced cost data from an invoice management system independent of the estimated cost management system and the order management system, 4) aggregating the estimated cost data, the quoted cost data, and the invoiced cost data in accordance with a data aggregation heuristic, and 5) automatically identifying one or more billing issues associated with a third-party vendor of a network provider based on the aggregated cost data.

### BACKGROUND INFORMATION

Delivery of a network circuit-based product (e.g., a private internet protocol (“PIP”) service or product, a switched circuit service or product, an Internet-based service or product, or a telecommunication-based service or product) to a customer by a network provider typically involves collaboration and coordination between numerous people, systems, and entities. For example, a network provider often has to contract with one or more third-party vendors to assist in performing one or more tasks associated with the delivery of the network circuit-based product. To illustrate, a network provider often has to rely on a local telecommunications provider to provision a tail circuit (e.g., an access line that connects a main network line owned by the network provider to customer premises equipment) when delivering a network circuit-based product to a customer.

Once a customer places an order for a network circuit-based product with a network provider, the network provider typically obtains a quote from a third-party vendor to perform a particular task associated with delivery of the network circuit-based product to the customer. The quote typically includes a quoted cost or price for performing the task. Once the task is completed, the third-party vendor provides the network provider with an invoice for performing the task.

For a variety of different reasons, the invoiced cost for performing a task sometimes differs from the quoted cost for performing the task. Unfortunately, because data representative of the quoted cost and the invoiced cost are often maintained in independent systems and because of the sheer volume of quotes and invoices handled by network providers on a daily basis, it is often difficult, time consuming, and ineffective to verify that invoiced costs and quoted costs match for each performed task, follow up with third-party vendors if the invoiced costs and the quoted costs do not match, and ensure that both the quoted and invoiced costs are in line with what the network provider expects.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary process that may be performed by a network provider when delivering a network circuit-based product to a customer according to principles described herein.

FIG. 2 illustrates an exemplary cost control system according to principles described herein.

FIG. 3 illustrates an exemplary configuration wherein the cost control system of FIG. 2 is communicatively coupled to a plurality of independent systems configured to maintain the various types of cost data described herein according to principles described herein.

FIGS. 4-5 show exemplary graphical user interfaces that may be presented according to principles described herein.

FIG. 6 illustrates a method of controlling costs associated with a third-party vendor of a network provider according to principles described herein.

FIG. 7 illustrates another method of controlling costs associated with a third-party vendor of a network provider according to principles described herein.

FIG. 8 illustrates an exemplary computing device according to principles described herein.

### DETAILED DESCRIPTION OF PREFERRED EMBODIMENTS

Methods and systems for controlling costs associated with a third-party vendor of a network provider are described herein. For example, a cost control system associated with a network provider may acquire estimated cost data (i.e., data generated prior to an order for a network circuit-based product being placed by a customer and representative of an estimated cost for a third-party vendor to perform a task associated with a delivery of the network circuit-based product to the customer by the network provider) from an estimated cost management system, quoted cost data (i.e., data provided in a quote by the third-party vendor in response to the order being placed and representative of a quoted cost for the third-party vendor to perform the task) from an order management system independent of the estimated cost management system, and invoiced cost data (i.e., data provided in an invoice by the third-party vendor and representative of an invoiced cost for performing the task) from an invoice management system independent of the estimated cost management system and the order management system. The cost control system may then aggregate the estimated cost data, quoted cost data, and invoiced cost data in accordance with a data aggregation heuristic and automatically identify one or more billing issues associated with the third-party vendor based on the aggregated cost data.

In some examples, the cost control system may be further configured to present the aggregated cost data, data representative of the identified one or more billing issues, and/or one or more options configured to facilitate resolution of the identified one or more billing issues within a graphical user interface (“GUI”). In this manner, a user associated with the network provider (e.g., a billing administrator) may readily identify billing anomalies, trends, and/or other areas of concern with respect to the cost of using a particular third-party vendor to perform tasks associated with delivery of network circuit-based products to customers. This, in turn, may allow the network provider to avoid and/or minimize overpayment to third-party vendors for services rendered, reduce operating expenses, maximize payment efficiencies (e.g., by reducing the time required to approve and pay invoices provided by third-party vendors), and provide a more cost-effective product to customers.

As used herein, a “network circuit” refers to any network-based communication path and associated components that may be provided by, used by, and/or otherwise associated with a network provider and/or customer of the network provider. For example, a network circuit may include a telecommunication circuit, a dedicated circuit, a switched circuit, an analog circuit, a digital circuit, a network path for a wide area network, a digital signal (“DS”) circuit (e.g., a T1, T2, or T3 line), and/or any other network-based communication path and associated components as may serve a particular implementation.

A “network circuit-based product” refers to any service or product associated with a network circuit and that may be offered (e.g., for sale or lease) by a network provider and/or any other entity to one or more customers. Exemplary network circuit-based products include, but are not limited to, private internet protocol (“PIP”) services and products, switched circuit services and products, Internet-based services and products, telecommunication-based services and products, and synchronous optical networking (“SONET”)-based services and products. As used herein, “delivery” of a network circuit-based product to a customer may require completion one or more tasks (e.g., one or more workflow tasks).

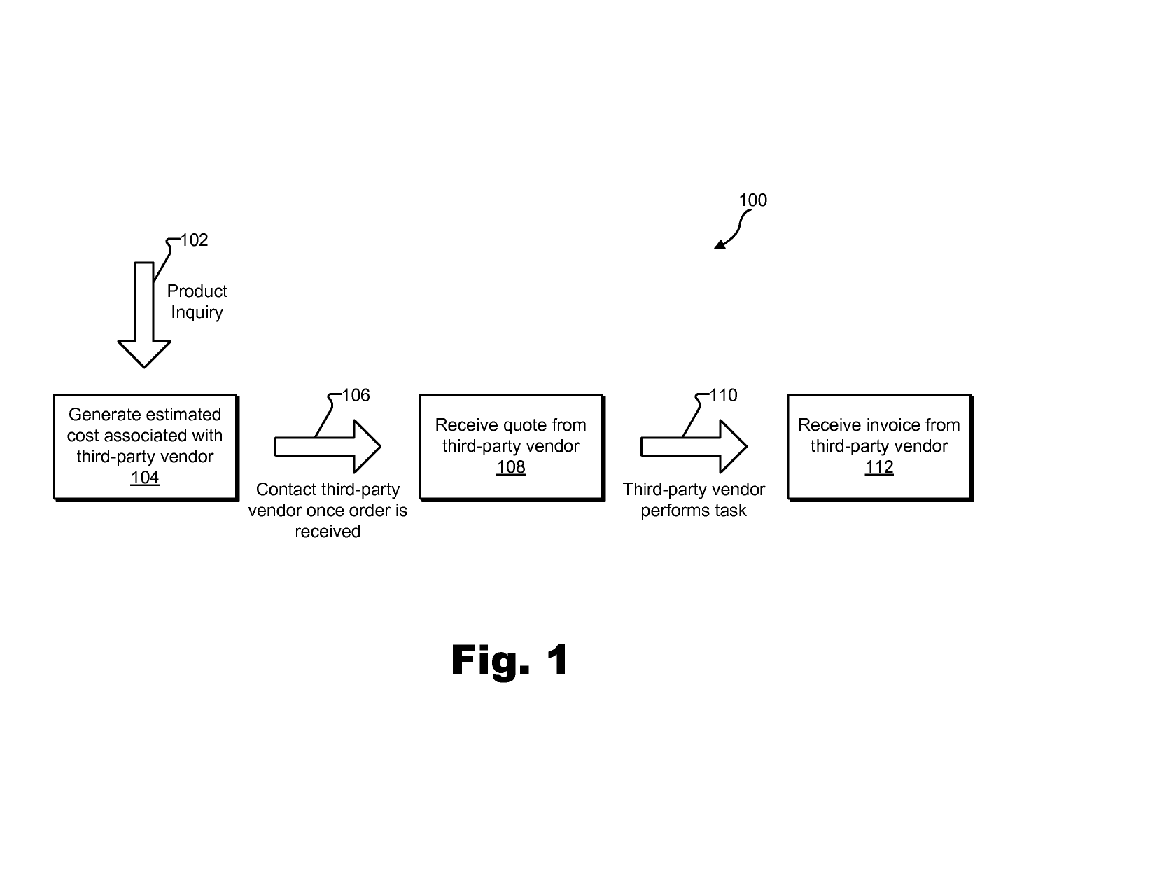

FIG. 1 illustrates an exemplary process 100 that may be performed by a network provider when delivering a network circuit-based product to a customer. As illustrated by arrow 102, an inquiry for a network circuit-based product may be initially received by the network provider. For example, a sales representative may notify the network provider that a potential customer is interested in placing an order for a particular network circuit-based product. In response, the network provider may generate an estimated cost for delivering the network circuit-based product.

As part of this estimate, the network provider may generate an estimated cost for a third-party vendor to perform a task associated with the delivery of the network circuit-based product to the customer (step 104). The task to be performed by the third-party vendor may include any task or service associated with the delivery of the network circuit-based product to the customer. For example, the task may include a provisioning of a tail circuit (e.g., an access line that connects a main network line owned by the network provider to the customer's equipment), a delivery and/or installation of a piece of equipment associated with the network circuit-based product, and/or any other task as may serve a particular implementation.

The estimated cost associated with the third-party vendor may be generated in step 104 in any suitable manner. For example, the network provider may generate the estimated cost associated with the third-party vendor based on standard pricing tools, special bidding processes, and/or in accordance with a master agreement between the third-party vendor and the network provider.

Once the overall estimated cost of delivering the network circuit-based product to the customer (including the estimated cost associated with the third-party vendor) has been generated, the sales representative may convey the estimated cost information to the customer. The customer may then place an order for the network circuit-based product. In response, as represented by arrow 106, the network provider may contact the third-party vendor and request a formal quote for the third-party vendor to perform the task associated with delivery of the network circuit-based product to the customer. The formal quote is received in step 108 and may include a quoted cost for performing the task associated with delivery of the network circuit-based product to the customer.

Once the network provider has accepted the quote, the third-party vendor performs the task, as represented by arrow 110. Upon completion of the task, the third-party vendor may submit an invoice to the network provider (step 112). The invoice may include an invoiced cost for performing the task.

In some examples, data representative of the estimated cost generated in step 104, the quoted cost included in the quote received in step 108, and the invoiced cost included in the invoice received in step 112 is maintained (e.g., stored and/or managed) in independent systems (e.g., in independent databases) by independent entities and/or personnel. For example, as will be described below, data representative of the estimated cost may be maintained in an estimated cost management system, data representative of the quoted cost may be maintained in an order management system, and data representative of the invoiced cost may be maintained in an invoice management system. As such, it has heretofore required great manual effort to ensure that invoiced costs match quoted costs, and that both quoted and invoiced costs are in line with what the network provider expects (i.e., that they match estimated costs). This has especially been the case for network providers that handle thousands of orders for network circuit-based products and that work with many different third-party vendors. As will be described below, the methods and systems described herein may automatically and intelligently combine and analyze estimated cost data, quoted cost data, and invoiced cost data in a way that allows a user to readily identify one or more billing issues associated with a third-party vendor.

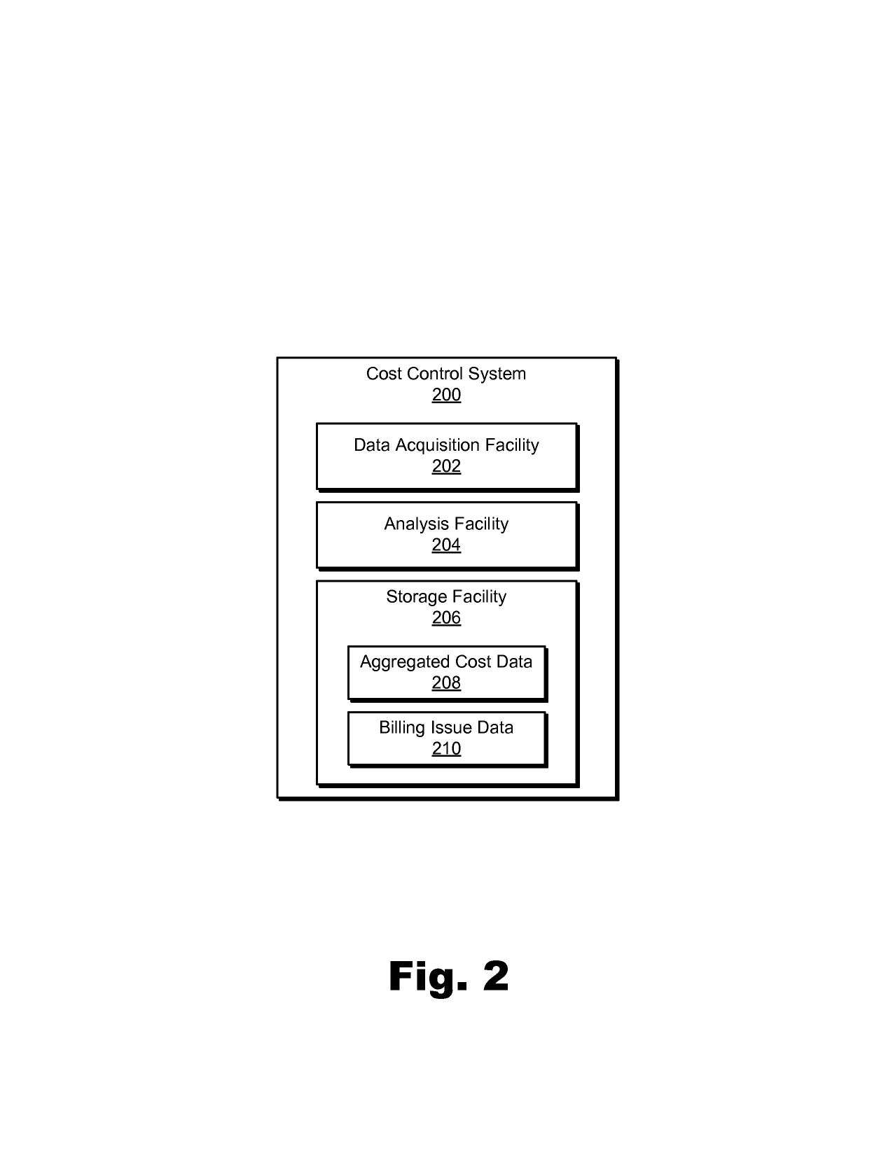

FIG. 2 illustrates an exemplary cost control system 200 (“system 200”). As shown, system 200 may include, without limitation, a data acquisition facility 202, an analysis facility 204, and a storage facility 206 selectively and communicatively coupled to one another. It will be recognized that although facilities 202-206 are shown to be separate facilities in FIG. 1, any of facilities 202-206 may be combined into fewer facilities, such as into a single facility, or divided into more facilities as may serve a particular implementation.

Data acquisition facility 202 may be configured to acquire various types of cost data from disparate sources. For example, data acquisition facility 202 may be configured to acquire estimated cost data from an estimated cost management system. As mentioned, the estimated cost data may be generated by the network provider prior to an order for a network circuit-based product being placed by a customer and is representative of an estimated cost for a third-party vendor to perform a task associated with a delivery of the network circuit-based product to the customer by the network provider.

Data acquisition facility 202 may be further configured to acquire quoted cost data from an order management system. As mentioned, the quoted cost data may be provided in a quote by the third-party vendor in response to the order being placed and is representative of a quoted cost for the third-party vendor to perform the task associated with the delivery of the network circuit-based product to the customer.

Data acquisition facility 202 may be further configured to acquire invoiced cost data from an invoice management system. As mentioned, the invoiced cost data may be provided in an invoice by the third-party vendor and is representative of an invoiced cost for performing the task associated with the delivery of the network circuit-based product to the customer.

The acquisition facility 202 may be further configured to acquire any other type of cost data as may serve a particular implementation. For example, data acquisition facility 202 may be configured to acquire revised cost data from the estimated cost management system. The revised cost data is representative of a revised estimated cost for the third-party vendor to perform the task associated with the delivery of the network circuit-based product to the customer and may be generated by the network provider subsequent to the order for the network circuit-based product being placed by the customer and before the third-party vendor provides the quoted cost data. For example, once the order for the network circuit-based product is placed, the network provider may perform a more detailed analysis of various factors affecting a cost of delivering the network circuit-based product and revise the estimated cost for the third-party vendor to perform the task associated with the delivery of the network circuit-based product to the customer. As will be described below, the revised cost data may be aggregated with the estimated cost data, the quoted cost data, and the invoiced cost data and used to identify one or more billing issues associated with the third-party vendor.

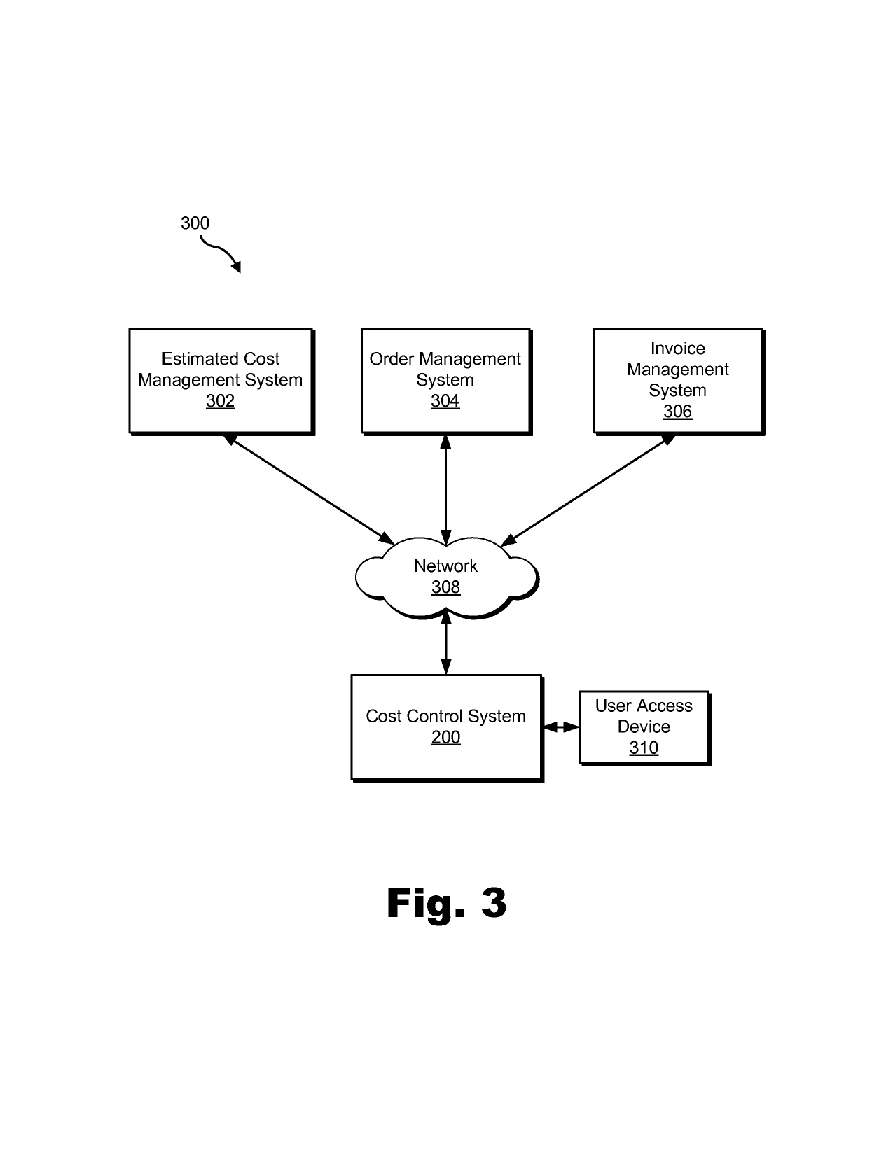

As mentioned, the estimated cost data, the quoted cost data, and the invoiced cost data may be acquired by data acquisition facility 202 from disparate sources. For example, FIG. 3 illustrates an exemplary configuration 300 wherein cost control system 200 is communicatively coupled to a plurality of independent systems configured to maintain the various types of cost data described herein. For example, cost control system 200 may be communicatively coupled to an estimated cost management system 302 configured to maintain the estimated cost data, an order management system 304 configured to maintain the quoted cost data, and an invoice management system 306 configured to maintain the invoiced cost data. Systems 302, 304, and 306 may be independent in that they do not communicate directly with one another, maintain data in incongruent formats, and/or are managed by independent entities, departments, and/or personnel.

As shown, cost control system 200 may communicate with systems 302, 304, and 306 by way of a network 308. Network 308 may include one or more networks or types of networks capable of carrying communications and/or data signals between cost control system 200 and systems 302, 304, and 306. For example, network 308 may include, but is not limited to, one or more wireless networks, broadband networks, closed media networks, cable networks, satellite networks, the Internet, intranets, local area networks, public networks, private networks, optical fiber networks, and/or any other networks capable of carrying data and communications signals between cost control system 200 and systems 302, 304, and 306. Additionally or alternatively, cost control system 200 may communicate directly one or more of systems 302, 304, and 306 without the use of network 308.

In some examples, cost control system 200 and/or systems 302, 304, and 306 may each include or be in communication with a user access device configured to facilitate user access to and/or control of one or more operations performed by cost control system 200 and/or systems 302, 304, and 306. For example, as shown in FIG. 3, cost control system 200 may be communicatively coupled to a user access device 310. User access device 310 may be configured to present one or more GUIs provided by cost control system 200 so that a user thereof may interact with cost control system 200. User access device 310 may include any suitable computing device such as, but not limited to, a personal computer, a communications device, a mobile device (e.g., a mobile phone or a tablet computer), a handheld device, and/or any other suitable computing device.

Returning to FIG. 2, data aggregation facility 202 may be configured to store the aggregated cost data for subsequent analysis by analysis facility 204. For example, data aggregation facility 202 may store the aggregated cost data within a SAS platform or within any other business analytics platform as may serve a particular implementation.

Analysis facility 204 may be configured to perform one or more operations with respect to the cost data acquired by data acquisition facility 202. For example, analysis facility 204 may be configured to aggregate the estimated cost data, the quoted cost data, and the invoiced cost data in accordance with a data aggregation heuristic. The estimated cost data, the quoted cost data, and the invoiced cost data may be aggregated any suitable manner. For example, the data aggregation heuristic may convert the estimated cost data, the quoted cost data, and the invoiced cost data from incongruent formats into a congruent format. In this manner, the estimated cost data, the quoted cost data, and the invoiced cost data may be more readily compared one with another. Additionally or alternatively, as will be described below, the data aggregation heuristic may combine and present the estimated cost data, the quoted cost data, and the invoiced cost data in a manner that allows a user to see the data side-by-side and thereby note discrepancies between the data.

Analysis facility 204 may be further configured to automatically identify one or more billing issues associated with a third-party vendor based on the aggregated cost data. This may be performed in any suitable manner. For example, analysis facility 204 may compare the estimated cost data, the quoted cost data, and/or the invoiced cost data and identify one or more billing issues associated with the third-party vendor based on the comparison. To illustrate, analysis facility 204 may identify a billing issue with the third-party vendor by determining that a difference between the invoiced cost and the quoted cost is above a predetermined threshold. Additionally or alternatively, analysis facility 204 may identify a billing issue with the third-party vendor by determining that a difference between the invoiced cost and the estimated cost and/or a difference between the quoted cost and the estimated cost are above a predetermined threshold.

Other data analysis heuristics may be used to identify one or more trends, anomalies, and/or discrepancies associated with the estimated cost data, the quoted cost data, and the invoiced cost data that may be indicative of a billing issues associated with the third-party vendor. For example, analysis facility 204 may determine that the third-party vendor consistently charges more than what was agreed upon to perform a particular type of task. Analysis facility 204 may then notify the network provider of this trend so that the network provider may bring the trend to the third-party vendor's attention.

As mentioned, data acquisition facility 202 may acquire any other type of cost data associated with the delivery of the network circuit-based product. Hence, analysis facility 204 may be further configured to take into account these other types of cost data when identifying the one or more billing issues associated with the third-party vendor. For example, data acquisition facility 202 may also acquire revised cost data generated by the network provider. In this case, analysis facility 204 may be further configured to aggregate the revised cost data with the estimated cost data, the quoted cost data, and the invoiced cost data in accordance with the data aggregation heuristic and automatically identify the one or more billing issues based on the aggregated cost data that includes the revised cost data.

Analysis facility 204 may be further configured to present the aggregated cost data and/or data representative of the identified one or more billing issues associated with the third-party vendor within a GUI. The GUI may include a web-based GUI, and application-specific GUI (e.g., a spreadsheet application GUI such as an Excel GUI), and/or any other type of GUI as may serve a particular implementation.

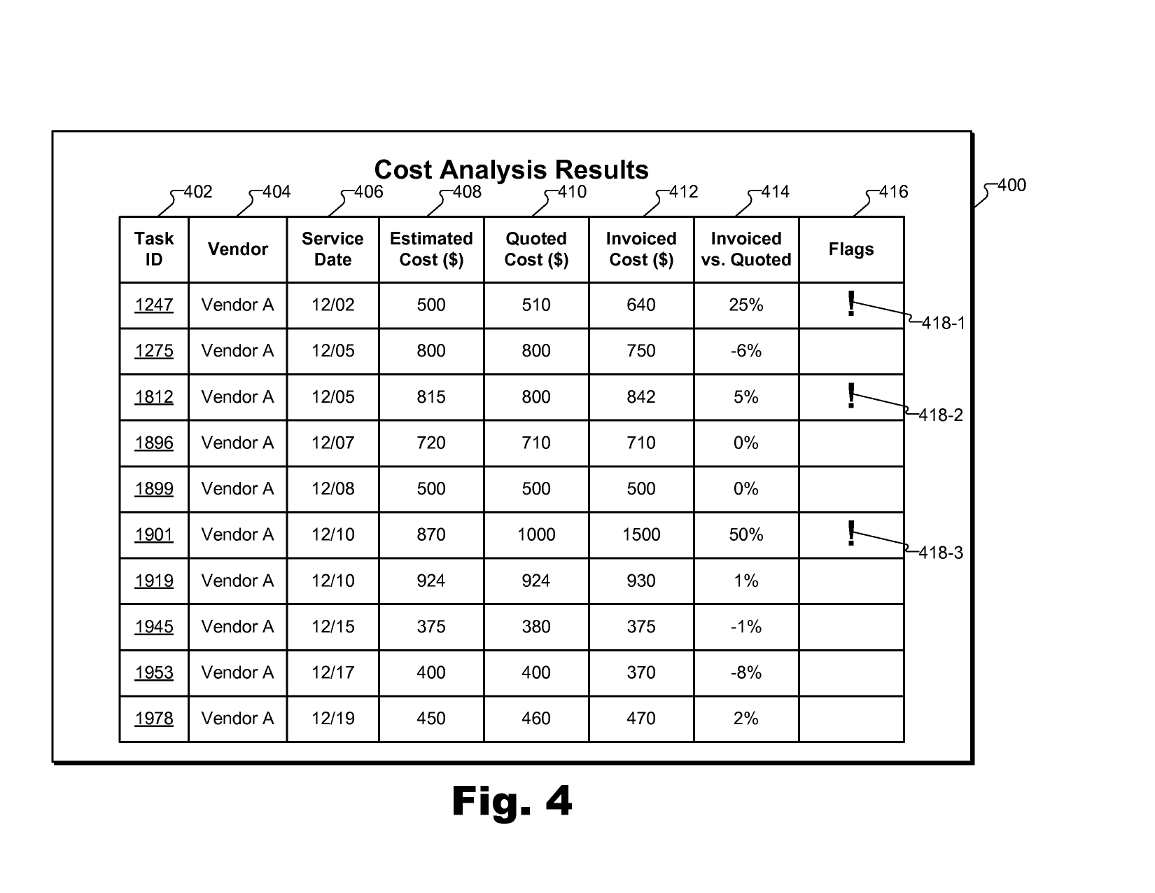

FIG. 4 shows an exemplary GUI 400 that may be presented by analysis facility 204 and that includes both aggregated cost data and data representative of various billing issues associated with a third-party vendor. As shown, GUI 400 may include various types of data associated with a plurality of tasks performed by a third-party vendor in association with delivery by a network provider of one or more network circuit-based products. For example, a task ID (e.g., 1247) associated with each task included in the plurality of tasks is indicated in column 402, a name of the third-party vendor (e.g., “vendor A”) that performs each task included in the plurality of tasks is indicated in column 404, a service date (e.g., 12/02) corresponding to each task included in the plurality of tasks is indicated in column 406, and aggregated cost data (e.g., an estimated cost amount, a quoted cost amount, and an invoiced cost amount) for each task included in the plurality of tasks is indicated in columns 408, 410, and 412.

In some examples, data representative of various billing issues associated with the third-party vendor may be presented within columns 414 and 416. For example, column 414 may present a comparison of the invoiced cost versus the quoted cost for each task presented in GUI 400. A positive number shown in column 414 may be indicative of a billing issue associated with a particular task.

To illustrate, FIG. 4 shows that the task having task ID 1247 has a quoted cost of $510 and an invoiced cost of $640. Column 414 shows that the invoiced cost is twenty-five percent higher than the quoted cost for this particular task, which may be indicative that the third-party vendor has overcharged the network provider for performing this particular task.

In contrast, FIG. 4 shows that the task having task ID 1275 has a quoted cost of $800 and an invoiced cost of $750. Column 414 shows that the invoiced cost is six percent lower than the quoted cost for this particular task, which may be indicative that the actual cost of performing the task was less than originally quoted.

In some examples, the data representative of the various billing issues presented within GUI 400 may include one or more graphical indications of the various billing issues. For example, FIG. 4 shows that graphical objects 418-1 through 418-3 (collectively “graphical objects 418”) are presented within column 416 to graphically indicate or flag a particular task as having a billing issue associated therewith. For example, in the example of FIG. 4, graphical objects 418 are presented for tasks that have an invoiced cost that exceeds its corresponding quoted cost by a predetermined threshold (e.g., four percent). In this manner, a user may immediately see which tasks (and, therefore, third-party vendors) have billing issues associated therewith.

It will be recognized that analysis facility 204 may alternatively present data representative of one or more identified billing issues within GUI 400 in any other manner as may serve a particular implementation. For example, one or more additional columns may be included within GUI 400 that present a comparison of the invoiced cost versus the estimated cost, a comparison of the quoted cost versus the estimated cost, and/or any other type of comparison of the aggregated cost data as may serve a particular implementation.

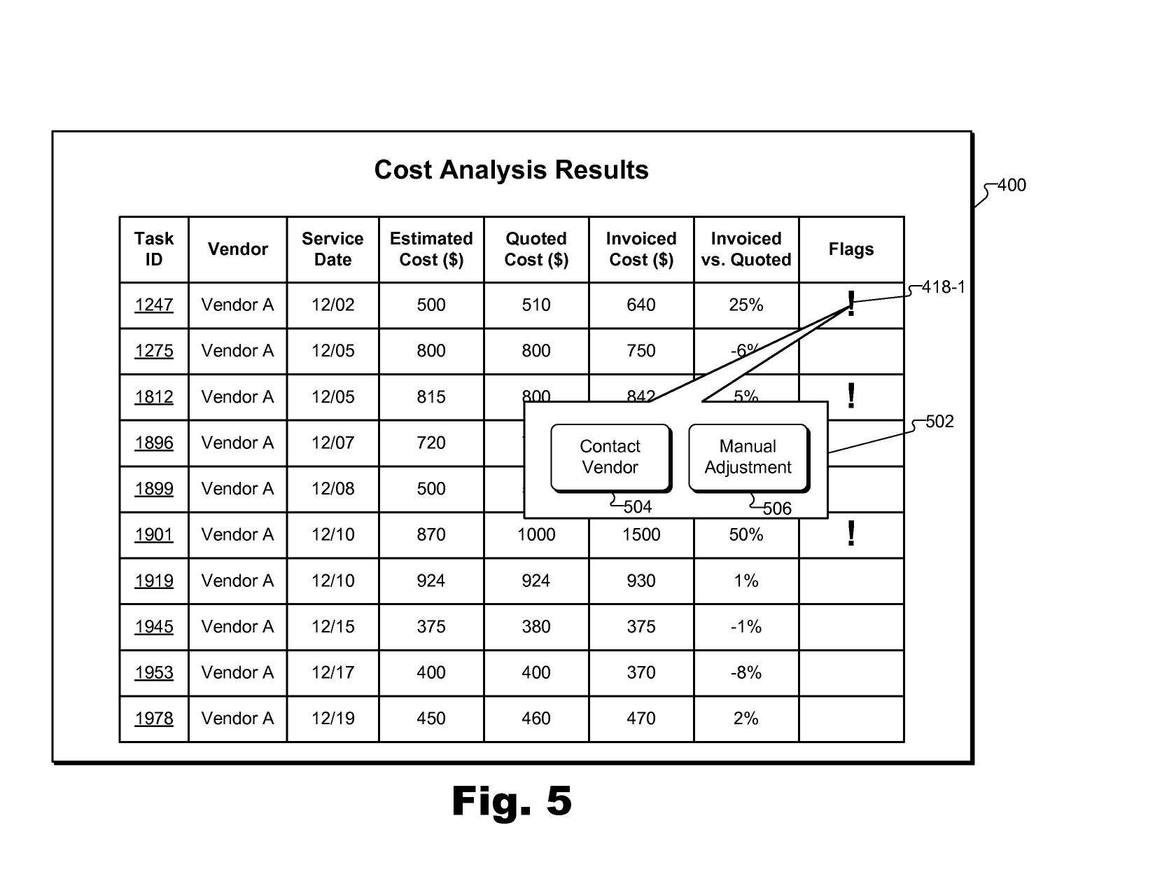

In some examples, analysis facility 204 may be further configured to present one or more options configured to facilitate resolution of the identified one or more billing issues. For example, FIG. 5 shows GUI 400 after a user has selected graphical object 418-1 (which, as described previously, represents a billing issue associated with a third-party vendor named “vendor A” and the task having task ID 1247). As shown, a pop-up window 502 including various options for resolving the identified billing issue may be presented within GUI 400 in response to the user selecting graphical object 418-1. For example, a user may select option 504 to contact the third-party vendor (e.g., by transmitting data representative of the billing issue to the third-party vendor, calling the third-party vendor, messaging the third party vendor, and/or otherwise communicating with the third-party vendor). Additionally or alternatively, the user may select option 506 to perform a manual adjustment of the estimated cost data and/or one or any other data associated with the task. For example, the user may manually adjust for one or more known and/or acceptable discrepancies between the invoiced cost and the quoted cost, modify data used to generate the estimated cost, and/or otherwise manually adjust data associated with the task.

In some examples, analysis facility 204 may be configured to automatically perform one or more options configured to resolve an identified billing issue. For example, analysis facility 204 may automatically transmit data representative of a discrepancy between the invoiced cost and the quoted cost for a particular task to the third-party vendor that performed the task. In this manner, the third-party vendor may be required to explain the discrepancy between the invoiced cost and the quoted cost and/or issue a refund to account for the discrepancy. The data may be transmitted to the third-party vendor using any suitable communication technologies and/or means.

Analysis facility 204 may be further configured to perform one or more other operations based on the aggregated cost data described herein. For example, analysis facility 204 may generate and present one or more other types of reports based on the aggregated cost data, export the aggregated cost data for use in connection with other data analysis tools, and/or otherwise process the aggregated cost data.

Returning to FIG. 2, storage facility 206 may be configured to maintain aggregated cost data 208 representative of aggregated estimated cost data, quoted cost data, and invoiced cost data. Storage facility 206 may be further configured to maintain billing issue data 210 representative of one or more billing issues identified for one or more third-party vendors. Storage facility 206 may maintain additional or alternative data as may serve a particular implementation.

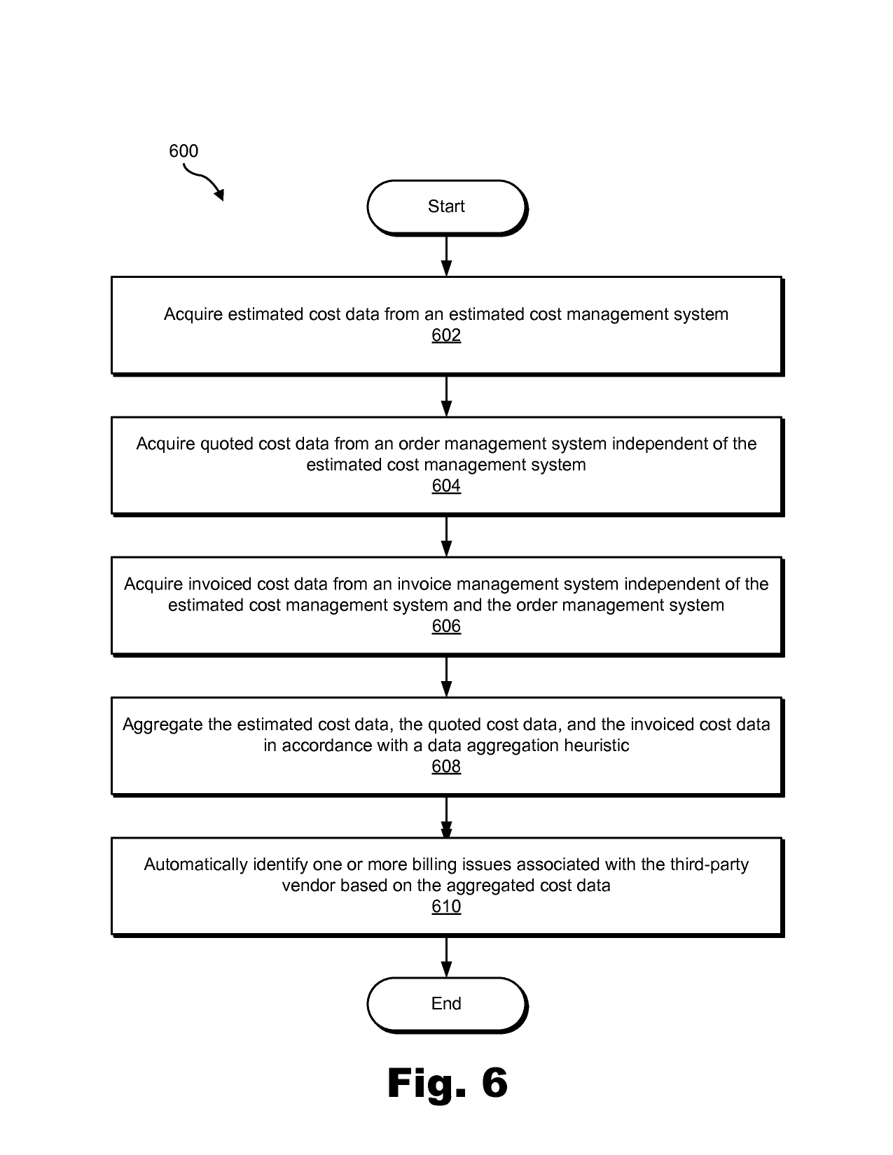

FIG. 6 illustrates a method 600 of controlling costs associated with a third-party vendor of a network provider. While FIG. 6 illustrates exemplary steps according to one embodiment, other embodiments may omit, add to, reorder, and/or modify any of the steps shown in FIG. 6. One or more of the steps shown in FIG. 6 may be performed by system 200 and/or any implementation thereof.

In step 602, a cost control system acquires estimated cost data from an estimated cost management system. Step 602 may be performed in any of the ways described herein.

In step 604, the cost control system acquires quoted cost data from an order management system independent of the estimated cost management system. Step 604 may be performed in any of the ways described herein.

In step 606, the cost control system acquires invoiced cost data from an invoice management system independent of the estimated cost management system and the order management system. Step 606 may be performed in any of the ways described herein.

In step 608, the cost control system aggregates the estimated cost data, the quoted cost data, and the invoiced cost data in accordance with a data aggregation heuristic. Step 608 may be performed in any of the ways described herein.

In step 610, the cost control system automatically identifies one or more billing issues associated with the third-party vendor based on the aggregated cost data. Step 610 may be performed in any of the ways described herein.

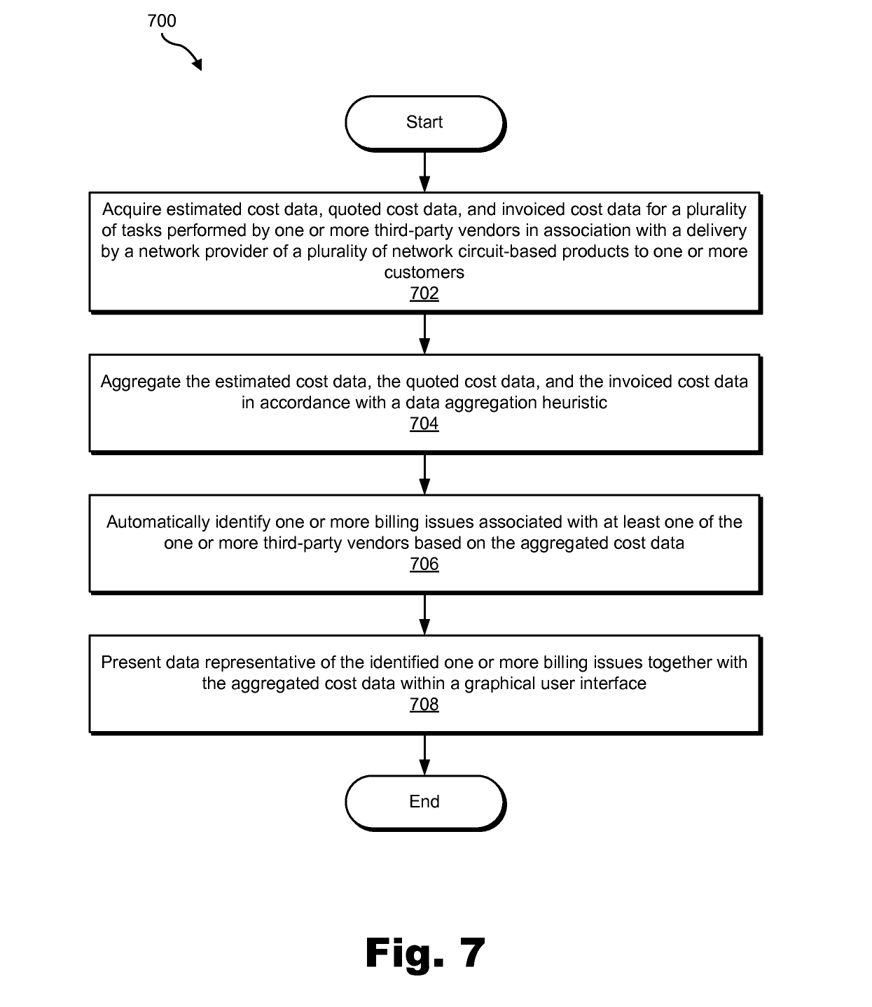

FIG. 7 illustrates a method 700 of controlling costs associated with a third-party vendor of a network provider. While FIG. 7 illustrates exemplary steps according to one embodiment, other embodiments may omit, add to, reorder, and/or modify any of the steps shown in FIG. 7. One or more of the steps shown in FIG. 7 may be performed by system 200 and/or any implementation thereof.

In step 702, a cost control system acquires estimated cost data, quoted cost data, and invoiced cost data for a plurality of tasks performed by one or more third-party vendors in association with a delivery by a network provider of a plurality of network circuit-based products to one or more customers. Step 702 may be performed in any of the ways described herein.

In step 704, the cost control system aggregates the estimated cost data, the quoted cost data, and the invoiced cost data in accordance with a data aggregation heuristic. Step 704 may be performed in any of the ways described herein.

In step 706, the cost control system automatically identifies one or more billing issues associated with at least one of the one or more third-party vendors based on the aggregated cost data. Step 706 may be performed in any of the ways described herein.

In step 708, the cost control system presents data representative of the identified one or more billing issues together with the aggregated cost data within a graphical user interface. Step 708 may be performed in any of the ways described herein.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

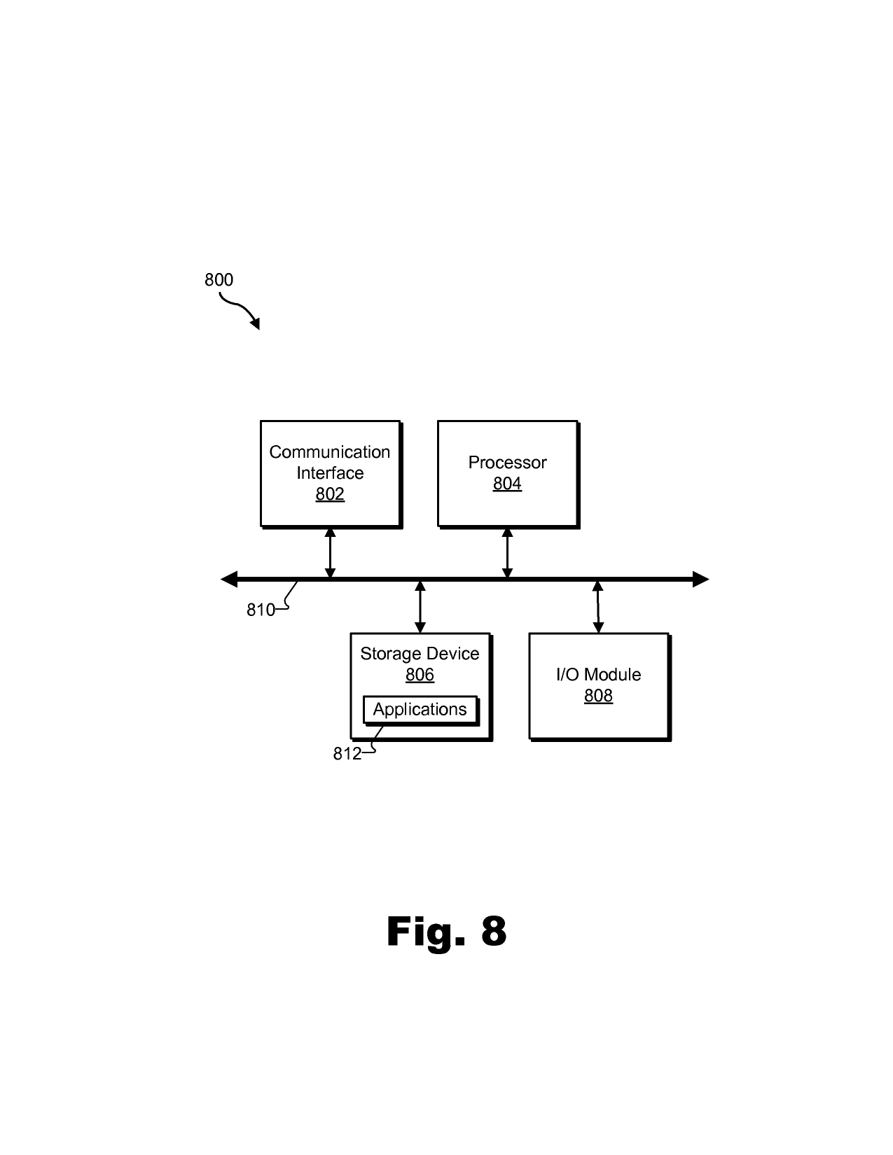

FIG. 8 illustrates an exemplary computing device 800 that may be configured to perform one or more of the processes described herein. As shown in FIG. 8, computing device 800 may include a communication interface 802, a processor 804, a storage device 806, and an input/output (“I/O”) module 808 communicatively connected via a communication infrastructure 810. While an exemplary computing device 800 is shown in FIG. 8, the components illustrated in FIG. 8 are not intended to be limiting. Additional or alternative components may be used in other embodiments. Components of computing device 800 shown in FIG. 8 will now be described in additional detail.

Communication interface 802 may be configured to communicate with one or more computing devices. Examples of communication interface 802 include, without limitation, a wired network interface (such as a network interface card), a wireless network interface (such as a wireless network interface card), a modem, an audio/video connection, and any other suitable interface.

Processor 804 generally represents any type or form of processing unit capable of processing data or interpreting, executing, and/or directing execution of one or more of the instructions, processes, and/or operations described herein. Processor 804 may direct execution of operations in accordance with one or more applications 812 or other computer-executable instructions such as may be stored in storage device 806 or another computer-readable medium.

Storage device 806 may include one or more data storage media, devices, or configurations and may employ any type, form, and combination of data storage media and/or device. For example, storage device 806 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 806. For example, data representative of one or more executable applications 812 configured to direct processor 804 to perform any of the operations described herein may be stored within storage device 806. In some examples, data may be arranged in one or more databases residing within storage device 806.

I/O module 808 may be configured to receive user input and provide user output and may include any hardware, firmware, software, or combination thereof supportive of input and output capabilities. For example, I/O module 808 may include hardware and/or software for capturing user input, including, but not limited to, a keyboard or keypad, a touch screen component (e.g., touch screen display), a receiver (e.g., an RF or infrared receiver), and/or one or more input buttons.

I/O module 808 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 808 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 800. For example, one or more applications 812 residing within storage device 806 may be configured to direct processor 804 to perform one or more processes or functions associated with data acquisition facility 202 and/or analysis facility 204. Likewise, storage facility 206 may be implemented by or within storage device 806.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
acquiring, by a cost control system associated with a network provider, estimated cost data from an estimated cost management system, the estimated cost data representative of an estimated cost for a third-party vendor to perform a task associated with a delivery of a network circuit-based product to a customer by the network provider and generated prior to an order for the network circuit-based product being placed by the customer;
acquiring, by the cost control system, quoted cost data from an order management system independent of the estimated cost management system, the quoted cost data provided in a quote by the third-party vendor in response to the order being placed and representative of a quoted cost for the third-party vendor to perform the task;
acquiring, by the cost control system, invoiced cost data from an invoice management system independent of the estimated cost management system and the order management system, the invoiced cost data provided in an invoice by the third-party vendor and representative of an invoiced cost for performing the task;
aggregating, by the cost control system, the estimated cost data, the quoted cost data, and the invoiced cost data in accordance with a data aggregation heuristic; and
automatically identifying, by the cost control system, one or more billing issues associated with the third-party vendor based on the aggregated cost data.

2. The method of claim 1, further comprising:
acquiring, by the cost control system, revised cost data from the estimated cost management system, the revised cost data representative of a revised estimated cost for the third-party vendor to perform the task and generated subsequent to the order for the network circuit-based product being placed by the customer and before the providing of the quoted cost data by the third-party vendor;
wherein the aggregating further comprises aggregating the revised cost data with the estimated cost data, the quoted cost data, and the invoiced cost data in accordance with the data aggregation heuristic; and
wherein the automatic identifying of the one or more billing issues is further based on the aggregated cost data that includes the revised cost data.

3. The method of claim 1, further comprising presenting, by the cost control system, data representative of the identified one or more billing issues associated with the third-party vendor within a graphical user interface.

4. The method of claim 1, further comprising presenting, by the cost control system within a graphical user interface, one or more options configured to facilitate resolution of the identified one or more billing issues.

5. The method of claim 1, further comprising presenting, by the cost control system, the aggregated cost data within a graphical user interface.

6. The method of claim 1, further comprising storing, by the cost control system, the aggregated cost data within a business analytics platform.

7. The method of claim 1, wherein the task performed by the third-party vendor comprises provisioning a tail circuit associated with the network circuit-based product.

8. The method of claim 1, wherein the one or more billing issues comprise one or more discrepancies between the estimated cost, the quoted cost, and the invoiced cost.

9. The method of claim 1, wherein the automatic identifying of the one or more billing issues comprises determining that a difference between the invoiced cost and the quoted cost is above a predetermined threshold.

10. The method of claim 1, wherein the estimated cost data is provided by the network provider.

11. The method of claim 1, wherein the aggregating of the estimated cost data, the quoted cost data, and the invoiced cost data in accordance with the data aggregation heuristic comprises converting the estimated cost data, the quoted cost data, and the invoiced cost data into a congruent format.

12. The method of claim 1, embodied as computer-executable instructions on at least one non-transitory computer-readable medium.

13. A method comprising:
acquiring, by a cost control system associated with a network provider, estimated cost data, quoted cost data, and invoiced cost data for a plurality of tasks performed by one or more third-party vendors in association with a delivery by the network provider of a plurality of network circuit-based products to one or more customers;
aggregating, by the cost control system, the estimated cost data, the quoted cost data, and the invoiced cost data in accordance with a data aggregation heuristic; and
automatically identifying, by the cost control system, one or more billing issues associated with at least one of the one or more third-party vendors based on the aggregated cost data; and
presenting, by the cost control system, data representative of the identified one or more billing issues together with the aggregated cost data within a graphical user interface.

14. The method of claim 13, embodied as computer-executable instructions on at least one non-transitory computer-readable medium.

15. A system comprising:
a data acquisition facility associated with a network provider and configured to
acquire estimated cost data from an estimated cost management system, the estimated cost data representative of an estimated cost for a third-party vendor to perform a task associated with a delivery of a network circuit-based product to a customer by the network provider and generated prior to an order for the network circuit-based product being placed by the customer,
acquire quoted cost data from an order management system independent of the estimated cost management system, the quoted cost data provided in a quote by the third-party vendor in response to the order being placed and representative of a quoted cost for the third-party vendor to perform the task, and
acquire invoiced cost data from an invoice management system independent of the estimated cost management system and the order management system, the invoiced cost data provided in an invoice by the third-party vendor and representative of an invoiced cost for performing the task; and
an analysis facility communicatively coupled to the data acquisition facility and configured to
aggregate the estimated cost data, the quoted cost data, and the invoiced cost data in accordance with a data aggregation heuristic, and
automatically identify one or more billing issues associated with the third-party vendor based on the aggregated cost data.

16. The system of claim 15, wherein:
the data acquisition facility is further configured to acquire revised cost data from the estimated cost management system, the revised cost data representative of a revised estimated cost for the third-party vendor to perform the task and generated subsequent to the order for the network circuit-based product being placed by the customer and before the providing of the quoted cost data by the third-party vendor; and
the analysis facility is further configured to
perform the data aggregation by aggregating the revised cost data with the estimated cost data, the quoted cost data, and the invoiced cost data in accordance with the data aggregation heuristic, and
automatically identify the one or more billing issues based on the aggregated cost data that includes the revised cost data.

17. The system of claim 15, wherein the analysis facility is further configured to present data representative of the identified one or more billing issues associated with the third-party vendor within a graphical user interface.

18. The system of claim 15, wherein the analysis facility is further configured to present one or more options configured to facilitate resolution of the identified one or more billing issues.

19. The system of claim 15, wherein the analysis facility is further configured to present the aggregated cost data within a graphical user interface.

20. The system of claim 15, wherein the task performed by the third-party vendor comprises provisioning a tail circuit associated with the network circuit-based product.
